(19) United States
(12) Patent Application Publication
(10) Pub. No.: US 2010/0253166 A1
(43) Pub. Date: Oct. 7, 2010

(54) Rotor and Vibration Motor

(76) Inventor: Young Il Park, Gyeonggi-do (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/522,344

(22) PCT Filed: Oct. 16, 2008
(86) PCT No.: PCT/KR2008/006124

§ 371 Date: Jul. 7, 2009

(30) Foreign Application Priority Data
Oct. 16, 2007 (KR) 10-2007-0104000
Oct. 16, 2008 (KR) 10-2008-0101635

(51) Int. Cl. H02K 7/075

(52) U.S. Cl. 310/81

(57) ABSTRACT

Disclosed are a rotor and a vibration motor. The rotor includes a rotor substrate, a coil electrically connected to the in rotor substrate, a coil cover for supporting the coil and a weight coupled to the coil cover.

### TECHNICAL FIELD

The present invention relates to a rotor and a vibration motor.

### BACKGROUND ART

A vibration motor includes a support shaft installed between a lower case and an upper case coupled to each other, in which an eccentric rotor is rotatably installed on the support shaft and a stator is installed on the lower case.

When the rotor interacts with the stator, the eccentric rotor rotates to generate vibration.

### DISCLOSURE OF INVENTION

### Technical Problem

The embodiment provides a rotor and a vibration motor having a novel structure.

The embodiment provides a vibration motor having a slim structure.

The embodiment provides a vibration motor, which is fabricated by employing a surface mount technology.

### Technical Solution

A rotor according to the embodiment comprises a rotor substrate, a coil electrically connected to the rotor substrate, a coil cover supporting the coil, and a weight coupled to the coil cover.

A rotor according to the embodiment comprises a rotor substrate, a coil cover faced to the rotor substrate, and a coil and a weight, wherein at least a portion of the coil and at least a portion of the weight are disposed between the rotor substrate and the coil cover.

A vibration motor according to the embodiment comprises a support shaft, a rotor rotatably coupled to the support shaft, and a stator faced to the rotor, wherein the rotor includes a rotor substrate, a coil electrically connected to the rotor substrate, a coil cover for supporting the coil and a weight coupled to the coil cover.

### Advantageous Effects

According to the embodiment, a rotor and a vibration motor having a novel structure can be provided.

According to the embodiment, a vibration motor having a slim structure can be provided.

According to the embodiment, a vibration motor can be fabricated by employing a surface mount technology.

### BRIEF DESCRIPTION OF DRAWINGS

FIG. 1 is a sectional view showing a vibration motor according to an embodiment of the present invention;

FIG. 2 is an exploded perspective view showing the vibration motor according to the embodiment of the present invention;

FIG. 3 is a perspective view representing a rotor according to the embodiment; and

FIG. 4 is an exploded view showing the rotor according to the embodiment.

### MODE FOR THE INVENTION

Hereinafter, a rotor and a vibration motor according to an embodiment of the present invention will be described in detail with reference to accompanying drawings.

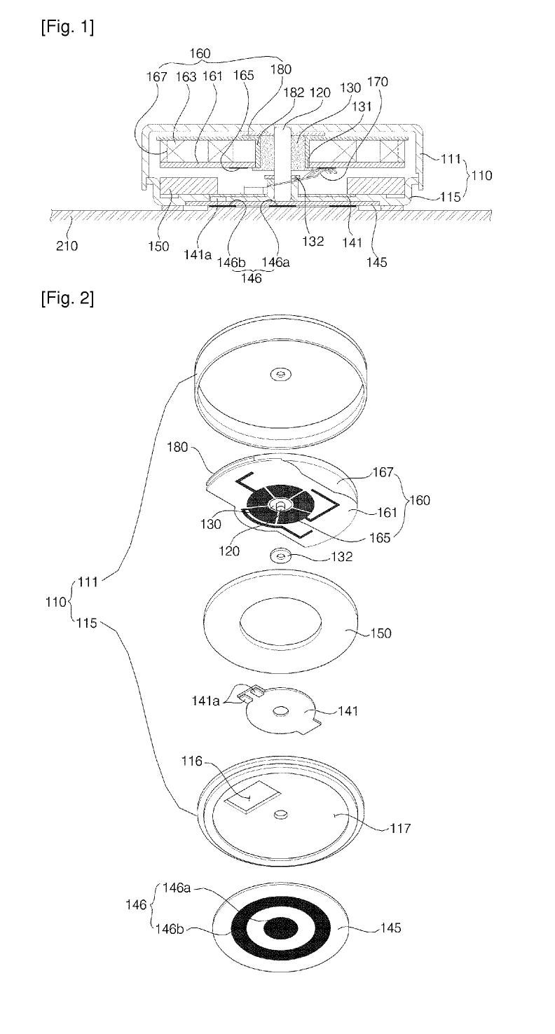

FIG. 1 is a sectional view showing a vibration motor according to an embodiment of the present invention, and FIG. 2 is an exploded perspective view showing the vibration motor according to the embodiment of the present invention.

As shown in FIGS. 1 and 2, a case 110 includes an upper case 111 and a lower case 115. The case 110 defines a space in which a rotor 160 and a stator 150 are installed. The upper case 111 is disposed at an upper side of the lower case 115 and coupled to the lower case 115.

The upper case 111 and the lower case 115 are fabricated by using the same material. Otherwise, the upper case 111 can be fabricated by using material different from that of the lower case 115. For example, the upper case 111 includes metal and the lower case 115 includes a printed circuit board. In the present embodiment, the upper case 111 and the lower case 115 are fabricated by using the same metallic material.

A support shaft 120 is installed in the case 110, and a bearing 130 is fitted around the support shaft 120. A first side of the support shaft 120 is supported by the upper case 111 and a second side of the support shaft 120 is supported by the lower case 115. For example, the support shaft 120 may be fixedly welded to the upper case 111 and/or the lower case 115.

A washer 132 is disposed between the bearing 130 and the lower case 115.

A first substrate 141 surrounding the support shaft 120 is fixed to a middle part of an upper surface of the lower case 115. A second substrate 145 electrically connected to the first substrate 141 is coupled to a lower surface of the lower case 115.

A connection terminal 141a electrically connected to the second substrate 145 is formed on the first substrate 141. The first connection terminal 141a is electrically connected to the second substrate 145 by passing through a through hole 116 formed in the lower case 115.

A mounting recess 117 is formed at the lower surface of the lower case 115 such that the second substrate 145 is accommodated in the mounting recess 117. Since the second substrate 145 is accommodated in the mounting recess 117, a thickness of a vibration motor can be reduced by a thickness of the second substrate 145. As a result, the vibration motor having a slim structure can be achieved.

An outer portion of the mounting recess 117 in the lower surface of the lower case 116 is fixedly soldered to a substrate 210 of a product having the vibration motor.

A power terminal 146 electrically connected to the substrate 210 of the product is formed on a lower surface of the second substrate 145. A terminal (not shown) electrically connected to the connection terminal 141a is formed on an upper surface of the second substrate 145.

The power terminal 146 includes an inner terminal 146a and an outer terminal 146b having a ring shape to surround the inner terminal 146a. A circuit pattern having a shape corresponding to the power terminal 146 can be formed on the substrate 210 of the product.

Accordingly, when the vibration motor is installed on the substrate 210 of the product, the vibration motor can be electrically connected to the substrate 210 of the product regardless of an orientation of the vibration motor.

The stator 150 having a ring shape is installed around the support shaft 120 at an upper part of the lower case 115. The stator 150 includes a magnet.

Meanwhile, the rotor 160 is coupled to the bearing 130 such that the rotor 160 rotates while interacting with the stator 150. As the rotator 160 rotates, vibration is generated due to eccentricity.

The rotor 160 includes a rotor substrate 161, a coil 163, a weight 167 and a coil cover 180.

The rotor substrate 161 includes a commutator 165 formed at a lower surface thereof. The coil 163 is installed on an upper surface of the rotor substrate 161 such that the coil 163 is electrically connected to the rotor substrate 161.

A brush 170 is installed on the first substrate 141. The brush 170 is electrically connected to the commutator 165 to supply power to the coil 163.

That is, the power supplied from the substrate 210 of the product is supplied to the coil 163 by sequentially passing through the second substrate 145, the connection terminal 141a, the first substrate 141, the brush 170 and the rotor substrate 161 including the commutator 165.

As power is supplied to the coil 163, the rotor 160 rotates while interacting with the stator 150.

The vibration motor according to the embodiment of the present invention is coupled to the lower surface of the lower case 115 and exposed to the outside. Therefore, the power terminal 146 of the second substrate 145 can be electrically connected to the substrate 210 of the product through an automation process, such as a reflow process.

In addition, since the lower surface of the lower case 115 is coupled to the substrate 210 of the product through the reflow process, the vibration motor can be easily assembled.

Meanwhile, the reflow process is performed under the high temperature of about 250° C. such that the vibration motor is coupled to the substrate 210 of the product through soldering. In this case, if the coil 163 of the rotor 160 and a resin molding member for supporting the coil 163 are swollen to make contact with surrounding components, the rotor 160 may not smoothly rotate.

For this reason, the vibration motor according to the embodiment of the present invention does not employ the molding member used for supporting the coil. Since the coil is supported without using the molding member, the surrounding components are prevented from making contact with the molding member swollen by heat. Even if the coil 163 is swollen due to the high temperature, since the coil 163 returns to the original state at the low temperature, the swollen coil 163 does not prevent the rotor 160 from rotating.

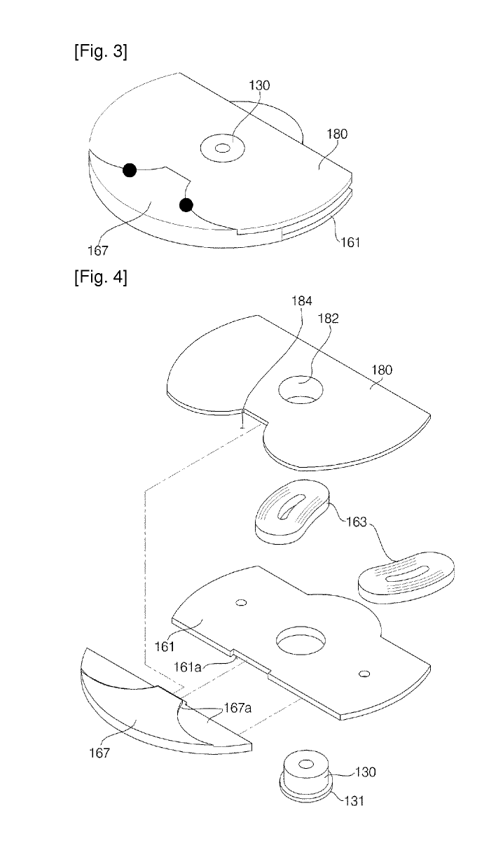

FIG. 3 is a perspective view representing a rotor according to the embodiment, and FIG. 4 is an exploded perspective view showing the rotor according to the embodiment.

As shown in FIGS. 3 and 4, the rotor 160 includes the rotor substrate 161, the coil 163, the weight 167 and the coil cover 180.

The rotor substrate 161 surrounds the bearing 130. The coil 163 is installed at the upper surface of the rotor substrate 161 and electrically connected to the rotor substrate 161.

The coil cover 180 may be disposed at an upper side of the rotor substrate 161 and the coil 163, and include a non-magnetic substance or a non-conductive substance. If the coil cover 180 includes a magnetic substance, the coil cover 180 is attracted toward the stator 150 including the magnet, so that rotation of the rotor 160 is disturbed. In this regard, the coil cover 180 preferably includes the non-magnetic substance. In addition, if the coil cover 180 includes a conductive substance, the coil 163 is electrically disconnected. In this case, an additional insulating member may be necessary.

A coupling pipe 182 having a cylindrical shape protrudes from a middle portion of the coil cover 180 such that an outer circumference of the bearing 130 is press-fitted into an inner circumference of the coupling pipe 182. As a result, the coil cover 180 is supported by the bearing 130.

The coupling pipe 182 extends downward from the coil cover 180, and disposed on the same horizontal plane as the coil 163 and the weight 167.

The coil 163 is bonded to the coil cover 180, so that the coil 163 is supported by the coil cover 180.

The coil 163 is disposed between the coil cover 180 and the rotor substrate 161. At least a portion of the coil 163 vertically overlaps with at least a portion of the coil cover 180. At least a portion of the coil 163 vertically overlaps with at least a portion of the rotor substrate 161. In addition, the coil 163, the rotor substrate 161 and the coil cover 180 partially overlap one another in the vertical direction.

The coil cover 180 and the rotor substrate 161 prevent the coil 163 from being swollen in the longitudinal direction, that is, the vertical direction by the high temperature. Even if the coil 163 is swollen in the vertical direction or the horizontal direction by the high temperature, since the embodiment of the present invention does not employ the molding member, the coil 163 returns to the original state at a low temperature.

The coil cover 180 is coupled to the weight 167, and the weight 167 is coupled to the rotor substrate 161. For example, the coil cover 180 and the weight 167 can be coupled through a welding process or a bonding process. In addition, the weight 167 and the rotor substrate 161 can be coupled through the welding process or the bonding process

The rotor substrate 161 is fixed to the coil 163 so as to be supported by the coil cover. Otherwise, the rotor substrate 161 is fixed to the weight 167 so as to be supported by the coil cover 180.

In addition, the rotor substrate 161 may be supported while making contact with a rim 131 formed at an outer circumference of a lower part of the bearing 30. Otherwise, the rotor substrate 161 may be coupled to the coupling pipe 182 of the coil cover 180.

Meanwhile, the weight 167 includes metallic material, and generates vibration through eccentric motion.

The weight 167 has a coil cover mounting part 167a formed at an upper surface thereof. The coil cover mounting part 167a has a shape corresponding to a portion of the coil cover 180 and is coupled to the portion of the coil cover 180. In addition, a recess 184 having a shape corresponding to the weight 167 is formed in the coil cover 180 toward the coupling pipe 182 such that the recess 168 is coupled to the weight 167.

A portion of a lower surface and a side surface of the coil cover 180 make contact with the coil cover mounting part 167a. The contact portion is coated with adhesive, so the coil cover 180 is coupled to the weight 167. Otherwise, as shown in FIG. 3, a boundary between the coil cover 180 and the weight 167 is welded such that the coil cover 180 is coupled to the weight 167.

An upper surface of the coil cover 180 is formed on the same horizontal plane as an upper surface of the weight 167.

In addition, the rotor substrate 161 has a recess part 161a corresponding to a shape of the weight 167 so as to be coupled to the weight 167.

A contact portion between the rotor substrate 161 and the weight 167 is coated with adhesive or welded, thereby coupling the rotor substrate 161 to the weight 167.

As described above, in the vibration motor according to the embodiment of the present invention, the coil is supported by the coil cover without using the resin molding member.

Since the resin molding member is not used, the conventional problem, in which the molding member is swollen during the surface mounting process, can be prevented. In addition, the coil can return to its original state at the low temperature without interfering with the molding member.

Although few embodiments of the present invention have been shown and described, it would be appreciated by those skilled in the art that changes may be made in these embodiments without departing from the principles and sprit of the invention, the scope of which is defined in the claims and their equivalents.

### INDUSTRIAL APPLICABILITY

The rotor and the vibration motor according to the embodiment can be applied to various electronic devices requiring vibration.

1. A rotor comprising:
a rotor substrate;
a coil electrically connected to the rotor substrate;
a coil cover supporting the coil; and
a weight coupled to the coil cover.

2. The rotor as claimed in claim 1, wherein at least a portion of the coil is disposed between the rotor substrate and the coil cover.

3. The rotor as claimed in claim 1, wherein the coil is bonded to the coil cover.

4. The rotor as claimed in claim 1, wherein the weight is welded or bonded to the coil cover.

5. The rotor as claimed in claim 1, wherein at least a portion of the weight vertically overlaps with at least a portion of the coil cover.

6. The rotor as claimed in claim 1, wherein an upper surface of the weight and an upper surface of the coil cover are disposed on a same horizontal plane.

7. The rotor as claimed in claim 1, wherein the coil cover includes a non-magnetic substance.

8. The rotor as claimed in claim 1, wherein the coil includes a winding coil that is supported without a molding member.

9. The rotor as claimed in claim 1, wherein the coil cover is provided with a coupling pipe having a cylindrical shape.

10. The rotor as claimed in claim 9, further comprising a bearing installed in the coupling pipe.

11. A rotor comprising:
a rotor substrate;
a coil cover faced to the rotor substrate; and
a coil and a weight, wherein at least a portion of the coil and at least a portion of the weight are disposed between the rotor substrate and the coil cover.

12. The rotor as claimed in claim 11, wherein the coil cover is provided with a coupling pipe having a cylindrical shape.

13. The rotor as claimed in claim 12, further comprising a bearing installed in the coupling pipe.

14. A vibration motor:
a support shaft:
a rotor rotatably coupled to the support shaft; and
a stator faced to the rotor,
wherein the rotor includes a rotor substrate, a coil electrically connected to the rotor substrate, a coil cover for supporting the coil and a weight coupled to the coil cover.

15. The vibration motor as claimed in claim 14, wherein the coil cover is provided with a coupling pipe having a cylindrical shape.

16. The vibration motor as claimed in claim 15, further comprising a bearing, which is supported by the support shaft and press-fitted into the coupling pipe.

17. The vibration motor as claimed in claim 14, further comprising an upper case, which is coupled to the support shaft and surrounds the rotor.

18. The vibration motor as claimed in 17, further comprising a lower case, which supports the stator and is coupled to the upper case.

19. The vibration motor as claimed in 18, further comprising a brush for supplying power to the rotor substrate.

20. The vibration motor as claimed in 19, further comprising a connection terminal, which is electrically connected to the brush by passing through the lower case, and a power terminal, which is formed at a lower surface of the lower case so as to be electrically connected to the connection terminal.
